(19) United States
(12) Patent Application Publication
(10) Pub. No.: US 2009/0150691 A1
(43) Pub. Date: Jun. 11, 2009

(54) POWER MANAGEMENT METHOD AND SYSTEM

(75) Inventors: Li-Ying Chen, Taipei (TW); Shang-Ching Hung, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei (TW)

(21) Appl. No.: 11/953,106

(22) Filed: Dec. 10, 2007

(51) Int. Cl. G06F 1/26

(52) U.S. Cl. 713/310; 713/300

(57) ABSTRACT

A power management system used to control a computer system. The power management system includes a general purpose input/output (GPIO) pin, a power control chip, and a controller. The GPIO pin outputs a power control signal. The power control chip receives the power control signal to power on or off the computer system. The controller controls the GPIO pin output the power control signal, sets the GPIO pin as an output pin while the GPIO pin outputs the power control signal, and then sets the GPIO pin as an input pin after the GPIO pin outputs the power control signal.

### BACKGROUND OF THE INVENTION

1. Field of the Invention

The invention relates to intelligent platform management interface (IPMI) management, and more particularly to IPMI methods and systems used to power on or off a computer system.

2. Description of the Related Art

With the popularity of electronic devices, such as computer systems, communication devices, and network devices, requirement for greater performance and execution stability has accordingly increased. For computer systems, intelligent platform management interface (IPMI) is an industry-standard protocol defining the monitoring and managing of hardware and firmware in a computer system, such as monitoring CPU/chip temperature, fan speed and information relative to the chassis, power on/off status, and others.

IPMI operates independently from the operating system of the computer system and allows system management in the absence of the operating system or system management software, or even if the system is not powered on. IPMI defines a plurality of interfaces, such as an intelligent platform management bus (IPMB), keyboard controller style (KCS), universal asynchronous receiver/transmitter (UART), or local area network (LAN). An IPMI system comprises a baseboard management controller (BMC) coupled with sensors in a chassis, and satellite management controllers via the I²C (Inter-Integrated Chip) implemented IPMB. The BMC receives detected data from the sensors and satellite management controllers, and stores the data in a storage unit.

As to power management, a local user may locally press a switch button on the chassis or remotely control the BMC to generate a trigger pulse to output to a power control pin, thus enabling a power control chip to power on or off the computer system. The power control type of the power control pin in most computer systems is set to “normal high”, which means a high voltage level is set when no negative pulse is received. The power control type of the power control pin in few computer systems, however, is set to “normal low”, which means a low voltage level is set when no positive pulse is received. It's difficult for a conventional BMC to determine whether the power control type is set to “normal high” or “normal low”, thus resulting in chassis control failure, which means that the local user cannot power on or off the computer system by pressing the switch button after the computer system whose power control type is “normal low” is first remotely power on or off.

Therefore, a heretofore unaddressed need exists in the art to address the aforementioned deficiencies and inadequacies.

### BRIEF SUMMARY OF THE INVENTION

The invention provides an embodiment of a power management system used to control a computer system. The power management system comprises a general purpose input/output (GPIO) pin, a power control chip, and a controller. The GPIO pin outputs a power control signal. The power control chip receives the power control signal to power on or off the computer system. The controller controls the GPIO pin output the power control signal, sets the GPIO pin as an output pin while the GPIO pin outputs the power control signal, and then sets the GPIO pin as an input pin after the GPIO pin outputs the power control signal.

The invention also provides an embodiment of a power management method used to control a computer system. A general purpose input/output (GPIO) pin is initialized as an input pin. Next, the GPIO pin is set as an output pin while the GPIO pin outputs a power control signal to power on or off the computer system. Finally, the GPIO pin is set as the input pin after the GPIO pin outputs the power control signal.

The invention further provides an embodiment of a machine-readable storage medium storing a computer program. The computer program performing a power management method comprises the following steps. First, a general purpose input/output (GPIO) pin is initialized as an input pin. Next, the GPIO pin is set as an output pin while the GPIO pin outputs the power control signal to power on or off the computer system. Lastly, the GPIO pin is set as the input pin after the GPIO pin outputs the power control signal.

### BRIEF DESCRIPTION OF THE DRAWINGS

The invention can be more fully understood by reading the subsequent detailed description and examples with references made to the accompanying drawings, wherein:

FIG. 1 shows an embodiment of a power management system according to the invention;

FIG. 2 shows two power control signals that may occur to power on or off the computer system;

FIG. 3 shows data stored in the storage unit in FIG. 1;

FIG. 4 shows another embodiment of a power management system according to the invention;

FIG. 5 shows two power control signals that may occur to power on or off the computer system;

FIG. 6 shows an embodiment of a power management method implementing the IPMI system according to the invention; and

FIG. 7 shows more detail concerning the step of generating a power control signal in FIG. 6.

### DETAILED DESCRIPTION OF THE INVENTION

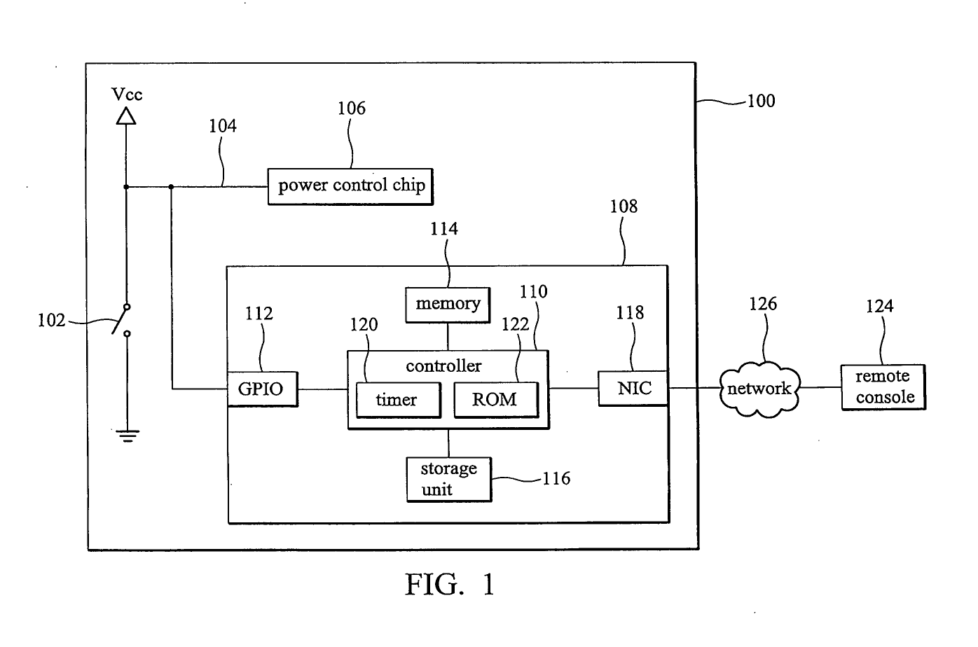

FIG. 1 shows an embodiment of a power management system used for a computer system according to the invention. A computer system 100 comprises a switch button 102, power control chip 106, and BMC card 108. It's known in the art that other components, such as a motherboard, CPU, video graphics array (VGA) card, hard disk, or others, may be included in computer system 100. Power control chip 106 comprises a power control pin 104 for receiving a power control signal from either switch button 102 or BMC card 108. Switch button 102 has two ends, one is coupled to the power supply Vcc and power control chip 106, and the other is coupled to the ground. It is noted that the power control type of power control pin 104 is “normal high”, i.e. power control pin 104 is connected to the power supply Vcc when no power on/off event occurs. The BMC card 108 implements the IPMI system and comprises controller 110, GPIO pin 112, memory 114, storage unit 116, and network interface card/chip/circuit (NIC) 118. Memory 114 may be a random access memory (RAM) such as dynamic random access memory (DRAM) or a static random access memory (SRAM). Storage unit 116 may be a non-volatile memory such as an electrically erasable programmable read-only memory (EEPROM) or a flash memory. It is noted that NIC 118 may not be included in BMC card 108 but embedded in a mainboard (not shown) instead. Controller 110, also referred to as BMC, could be a microprocessor and further comprise timer 120 and ROM 122. Controller 110 can control GPIO pin 112 output the power control signal to power control chip 106 through power control pin 104. Controller 110 sets GPIO pin 112 as an output pin while GPIO pin 112 outputs the power control signal to power control chip 106, and sets GPIO pin 112 as an input pin after GPIO pin 112 outputs the power control signal.

The computer system 100 can be remotely powered on or off by a remote console 124 through a network 126. It's known in the art that network 126 could be Internet, Intranet, Ethernet, local area network (LAN), wide area network (WAN), wireless network, wireless local area network (WLAN), general packet radio service (GPRS), wideband code division multiple access (WCDMA) or CDMA 2000, fiber distributed data interface (FDDI), infrared data association (IrDA), Bluetooth, TCP/IP, ATM, or others. Remote console 124 can issue a command indicating the computer system is to be powered on or off through network 126 to NIC 118. NIC 118 receives the command and then transmits it to controller 110. In one embodiment, the remote console may be personal computer, notebook computer, laptop computer, desktop computer, personal digital assistant (PDA), cellular phone or any portable electronic device.

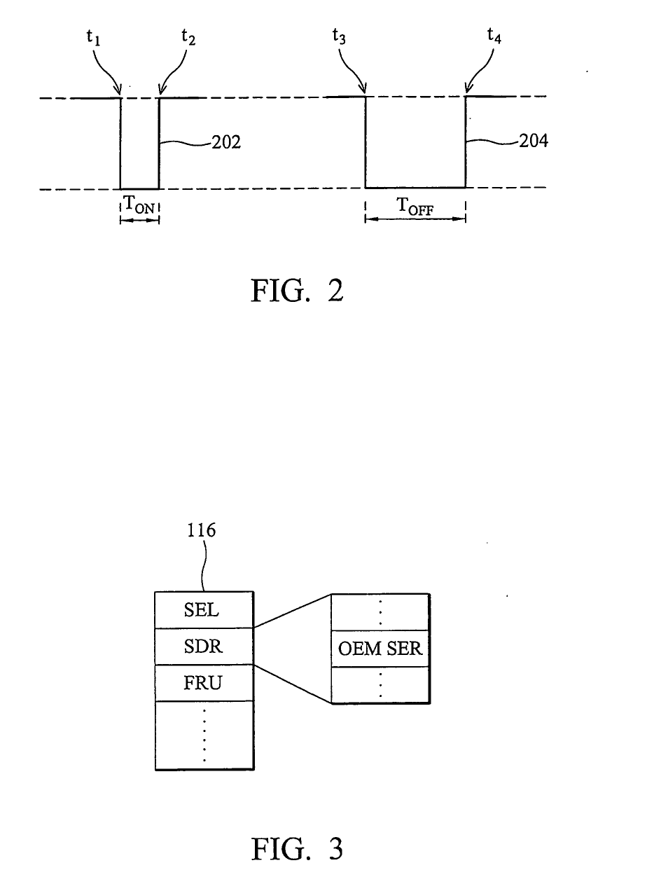

FIG. 2 shows two possible power control signals that may be generated from switch button 102 or controller 110. In one scenario, the power control signals are generated from a local user by pressing switch button 102. The user may press switch button 102 with a short press to allow switch button 102 a short period of time to connect to the ground and then disconnect from the ground, thereby generating a negative pulse 202 with duration T_{ON} as a power control signal to power on computer system 100. Additionally, the user may press switch button 102 with a longer press than T_{ON} to allow switch button 102 a long period of time to connect to the ground and then disconnect from the ground, thereby generating negative pulse 204 with duration T_{OFF} as a power control signal to power off computer system 100. In the other scenario, the power control signals are generated from controller 110. If negative pulse 202 is generated by controller 110, controller 110 will set GPIO pin 112 as an output pin to output negative pulse 202 during the time interval between time t1 and t2, and then set as an input pin after time t2. Similarly, if negative pulse 204 is generated by controller 110, controller 110 will set GPIO pin 112 as an output pin to output negative pulse 204 during the time interval between time t3 and t4, and then set as an input pin after time t4. Timer 120 can be used to count the duration of these single negative pulses. Finally, power control chip 106 may receive one of these negative pulses through power control pin 104 to power on or off computer system 100 according to the pulse duration. The duration of T_{ON}, for example, could be 1 second, and the duration of T_{OFF} could be 6 seconds. In one embodiment, the duration of T_{ON} is substantially larger than that of T_{OFF}.

Controller 110 can access a record stored in storage unit 116 to determine whether the power control type is “normal high” or “normal low”, and generate the power control signal accordingly. For example, controller 110 will generate a single negative pulse if the power control type indicates that power control pin 104 of power control chip 106 is normally at a high level (normal high). Referring to FIG. 3, data in the storage unit 116 at least comprises a sensor data record (SDR) repository, a field replaceable unit (FRU), and a system event logs (SELs). The SDR repository provides the properties of the individual sensors present on the motherboard. For example, sensors may be for temperature, fan speed, voltage, and others. The power control type can be stored as a record by manufacturers in original equipment manufacturer (OEM) SDR.

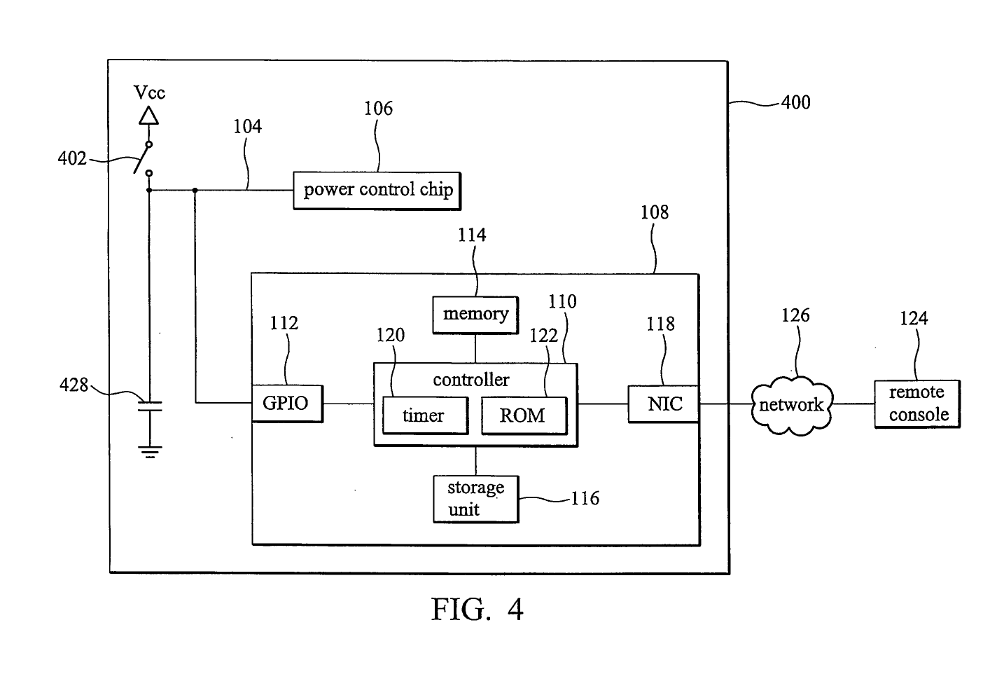

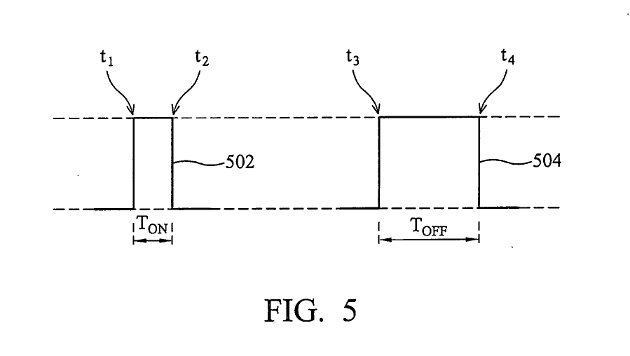

FIG. 4 shows another embodiment of a computer system 400 according to the invention. Power control chip 106 and the components of BMC card 108 are the same as FIG. 1 and not described hereafter for brevity. Different from FIG. 1, switch button 402 has one end coupled to the power supply Vcc, and the other end coupled to power control chip 106 and the ground through a capacitor 428. As a result, the power control type of power control pin 104 is “normal low” because power control pin 104 is connected to the ground when no power on/off event occurs.

Computer system 400 can also be remotely powered on or off by a remote console 124 through network 126. Remote console 124 issues a command indicating computer system 400 is to be powered on or off through network 126 to NIC 118. When the command is received, controller 110 can access a record stored in storage unit 116 to determine whether the power control type is “normal high” or “normal low”. In this embodiment, the record indicates that the power control type is “normal low”, so controller 110 will generate a single positive pulse as the power control signal.

FIG. 5 shows two possible power control signals that may be generated from switch button 402 or controller 110. In one scenario, the power control signals are generated from a local user by pressing switch button 402. The user may press switch button 402 with a short press to allow switch button 402 a short period of time to connect to the power supply Vcc and then disconnect from the power supply Vcc, thereby enabling capacitor 428 to be charged and then discharged to generate a positive pulse 502 with duration T_{ON} to power on computer system 400. Additionally, the user may press switch button 402 with a longer press than T_{ON} to allow switch button 402 a long period of time to connect to the power supply Vcc and then disconnect from the power supply Vcc, thereby generating another positive pulse 504 with duration T_{OFF} to power off computer system 400. In the other scenario, the power control signals are generated from controller 110. If positive pulse 502 is generated by controller 110, controller 110 will set GPIO pin 112 as an output pin to output positive pulse 502 during the time interval between time t1 and t2, and then set as an input pin after time t2. Similarly, if positive pulse 504 is generated by controller 110, controller 110 will set GPIO pin 112 as an output pin to output positive pulse 504 during the time interval between time t3 and t4, and then set as an input pin after time t4. Timer 120 can be used to count the duration of these single positive pulses. Finally, power control chip 106 may receive one of these positive pulses through power control pin 104 to power on or off computer system 400 according to the pulse duration. In one embodiment, the duration of T_{ON} is substantially larger than that of T_{OFF}.

According to FIGS. 1-5, one skilled in the art can appreciated that controller 110 can be implemented in both power control types of “normal low” and “normal high” without any hardware or software modification, because controller 110 can read the power control type stored by manufacturer from storage unit 116 and generate the power control signal according to the power control type. One skilled in the art can also appreciated that the computer systems 100 and 400 are free from chassis control failure, because GPIO pin 112 is set as an output pin only when the power control signal generated by controller 110 is output.

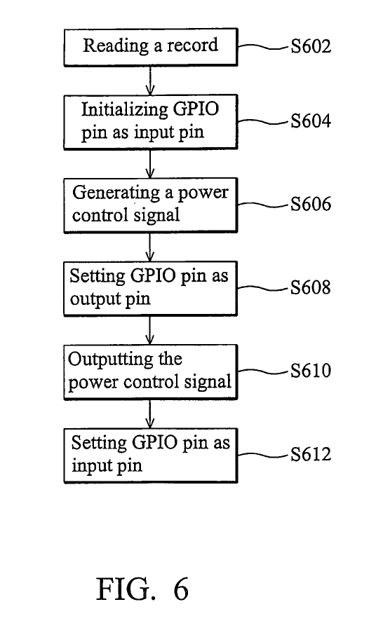

FIG. 6 shows an embodiment of a power management method implementing the IPMI system to control a computer system according to the invention. First, a record indicating a power control type of the computer system is read (step 602), and a general purpose input/output (GPIO) pin is initialized as an input pin (step 604). Next, a power control signal is generated according to the power control type (step 606). In one embodiment, the power control signal is generated when a command generated from a remote console is received. In another embodiment, the power control signal is generated as a single pulse with specific pulse duration. The GPIO pin is set as an output pin (step 608) while the power control signal is output to power on or off the computer system (step 610). Finally, the GPIO pin is set as the input pin again after the power control signal is output (step 610).

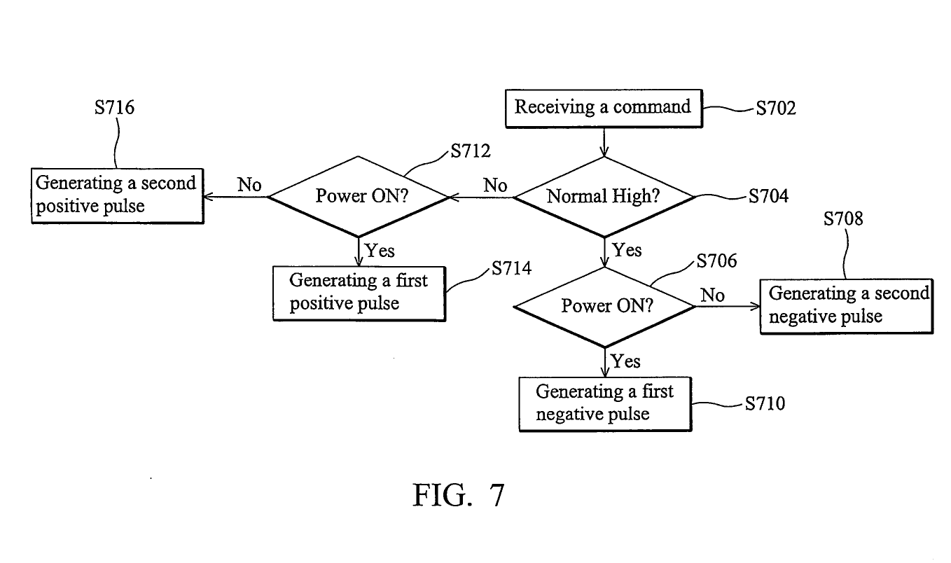

FIG. 7 shows more detail concerning step 606 in FIG. 6. When a command generated from a remote console is received (step S702), the record is examined to determine the power control type is normal high or normal low (step S704). If the power control type is normal high, then the command is examined to decide whether the computer system is to be powered on or off (step S706). If the command indicates that the computer system is to be powered on, the power control signal is generated as a first negative pulse (step S710), otherwise, the power control signal is generated as a second negative pulse with longer or shorter duration than the first negative pulse (step S708). Meanwhile, if the power control type is normal low, then the command is examined to decide whether the computer system is to be powered on or off (step S712). If the command indicates that the computer system is to be powered on, the power control signal is generated as a first positive pulse (step S714), otherwise, the power control signal is generated as a second positive pulse with longer or shorter duration than the first positive pulse (step S708).

In an embodiment of the invention, the power management methods described in FIGS. 6-7 can be implemented as hardware, firmware, software, or the combination thereof. Take FIG. 1 for example, the power management methods can be implemented as computer programs and be further stored in ROM 122. When controller 110 executes the computer programs, the computer programs may be downloaded to memory 114 for fast access by controller 110.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power management system, used to control a computer system, comprising:
a general purpose input/output (GPIO) pin, configured to output a power control signal;
a power control chip, configured to receive the power control signal to power on/off the computer system; and
a controller, configured to control the GPIO pin output the power control signal, wherein the controller sets the GPIO pin as an output pin while the GPIO pin outputs the power control signal, and then sets the GPIO pin as an input pin after the GPIO pin outputs the power control signal.

2. The power management system of claim 1, further comprising a network interface configured to receive a command generated from a remote console and transfer the command to the controller, wherein the command indicates that the computer system is to be power on or off.

3. The power management system of claim 1, further comprising a storage unit configured to store a record indicating a power control type of the computer system.

4. The power management system of claim 3, wherein the power control signal is a single positive pulse if the power control type indicates that a power control pin of the power control chip is normally at a low level.

5. The power management system of claim 4, further comprising a switch button, wherein the switch button has a first end coupled to a power supply, and a second end coupled to the power control chip and a ground through a capacitor.

6. The power management system of claim 3, wherein the power control signal is a single negative pulse if the power control type indicates that a power control pin of the power control chip is normally at a high level.

7. The power management system of claim 6, further comprising a switch button, wherein the switch button has a first end coupled to a power supply and the power control chip, and a second end coupled to a ground.

8. The power management system of claim 1, wherein the power control signal is a single pulse and the controller further comprises a timer configured to count a duration of the single pulse.

9. The power management system of claim 8, wherein the duration of the single pulse powering on the computer system is shorter than that of the single pulse powering off the computer system.

10. A power management method, used to control a computer system, comprising the steps of:
initializing a general purpose input/output (GPIO) pin as an input pin;
setting the GPIO pin as an output pin while the GPIO pin outputs a power control signal to power on or off the computer system; and
setting the GPIO pin as the input pin after the GPIO pin outputs the power control signal.

11. The power management method of claim 10, wherein the power control signal is generated by receiving a command generated from a remote console and generating the power control signal to power on or off the computer system according the command.

12. The power management method of claim 10, further comprising:
reading a record indicating a power control type of the computer system; and
generating the power control signal according to the power control type.

13. The power management method of claim 12, wherein the power control signal is generated as a single positive pulse if the power control type indicates that a power control pin of a power control chip of the computer system is normally at a low level.

14. The power management method of claim 12, wherein the power control signal is generated as a single negative pulse if the power control type indicates that a power control pin of a power control chip of the computer system is normally at a high level.

15. The power management method of claim 10, wherein the power control signal is generated either as a first pulse having a first duration to power on the computer system or as a second pulse having a second duration longer than the first duration to power off the computer system.

16. A machine-readable storage medium storing a computer program, the computer program performing a power management method comprising the steps of:
initializing a general purpose input/output (GPIO) pin as an input pin;
setting the GPIO pin as an output pin while the GPIO pin outputs a power control signal to power on or off the computer system; and
setting the GPIO pin as the input pin after the GPIO pin outputs the power control signal.

17. The machine-readable storage medium of claim 16 further comprising:
reading a record indicating a power control type of the computer system; and
generating the power control signal according to the power control type.

18. The machine-readable storage medium of claim 17, wherein the power control signal is generated as a single positive pulse if the power control type indicates that a power control pin of a power control chip of the computer system is normally at a low level.

19. The machine-readable storage medium of claim 17, wherein the power control signal is generated as a single negative pulse if the power control type indicates that a power control pin of a power control chip of the computer system is normally at a high level.

20. The machine-readable storage medium of claim 16, wherein the power control signal is generated either as a first pulse having a first duration to power on the computer system or as a second pulse having a second duration longer than the first duration to power off the computer system.
